(19) United States
(12) Patent Application Publication
(10) Pub. No.: US 2015/0099115 A1
(43) Pub. Date: Apr. 9, 2015

(54) MAGNETIC MATERIAL COMPOSITION AND COIL COMPONENT

(71) Applicant: MURATA MANUFACTURING CO., LTD., Kyoto-fu (JP)

(72) Inventors: Eiichi MAEDA, Kyoto-fu (JP); Toru TAKAHASHI, Kyoto-fu (JP)

(73) Assignee: MURATA MANUFACTURING CO., LTD., Kyoto-fu (JP)

(21) Appl. No.: 14/572,645

(22) Filed: Dec. 16, 2014

Related U.S. Application Data
(63) Continuation of application No. PCT/JP2013/071518, filed on Aug. 8, 2013.

(30) Foreign Application Priority Data
Aug. 10, 2012 (JP) 2012-178191

(51) Int. Cl. H01F 1/01; H01F 27/255

(52) U.S. Cl. CPC H01F 1/01; H01F 27/255
USPC 428/370; 252/62.53

(57) ABSTRACT

A magnetic material composition includes: magnetic alloy particles such as Fe—Si—Cr or Fe—Si—Al based particles, with a passivation film formed on the surfaces of the particles; and a glass constituent that contains Si, B, and an alkali metal such as K, Na, and Li, and has a softening point of 650 to 800° C. The content of the glass constituent is 12 to 32 wt % with respect to the total of the magnetic alloy particles and the glass constituent. A glass phase formed from the glass constituent is formed between the magnetic alloy particles. A component body with a coil conductor buried therein is formed from the magnetic material composition. Thus, ingress of moisture and plating solutions between the magnetic alloy particles can be suppressed so that favorable insulation performance can be ensured without impairing any magnetic property.

### CROSS REFERENCE TO RELATED APPLICATIONS

This application claims benefit of priority to Japanese Patent Application No. 2012-178191 filed Aug. 10, 2012, and to International Patent Application PCT/JP2013/071518 filed Aug. 8, 2013, the entire content of each of which is incorporated herein by reference.

### TECHNICAL FIELD

The present technical field relates to a magnetic material composition and a coil component, and more particularly, relates to a magnetic material composition containing a magnetic alloy material as its main constituent, and various types of coil components using the magnetic material composition.

### BACKGROUND

Conventionally, magnetic material compositions that contain magnetic alloy particles as their main constituent and have excellent direct-current superimposition characteristics are widely used in coil components for use in choke coils for use at high frequencies, power inductors for power circuits and DC/DC converter circuits for carrying a large current, etc.

This type of magnetic alloy materials are high in saturated magnetic flux density, and unlikely to reach magnetic saturation, but low in insulation performance as compared with ferrite materials, and thus required to be subjected to insulation treatment.

Therefore, for example, Japanese Patent Application Laid-Open No. 2011-249774 proposes a coil-type electronic component where a body is composed of particles of soft magnetic alloy containing Fe, Si, and an element such as Cr and Al, which is more likely to be oxidized than Fe, an oxidation layer formed by oxidation of each soft magnetic alloy particle is produced on the surface of the particle, the oxidation layer contains the element which is more likely to be oxidized than iron and larger in amount as compared with the alloy particle, and the particles are coupled to each other by means of the oxidation layer.

According to Japanese Patent Application Laid-Open No. 2011-249774, the oxidation layer such as a Cr oxide and an Al oxide formed by the oxidation of the soft magnetic particles is used as an insulating layer for the soft magnetic particles, there is thus no need for insulation treatment with a resin material or a glass material contained in the soft magnetic particles, and it is possible to obtain, at low cost, a magnetic material which is high in magnetic permeability and high in saturated magnetic flux density.

Furthermore, Japanese Patent Application Laid-Open No. 2010-62424 proposes a method for manufacturing an electronic component, where glass that contains SiO₂, B₂O₃, and ZnO as its main constituents, and that has a softening temperature of 600±50° C. is added to a magnetic alloy material containing Cr, Si, and Fe so that the glass is less than 10% of the magnetic alloy material in volume, a metallic magnetic material of the magnetic alloy material with the surface coated with the glass is used to form a compact with a coil built therein, and the compact is subjected to firing at a temperature of 700° C. or higher and less than the melting point of the coil conductor material in vacuum, or in a non-oxidizing atmosphere without oxygen or with a low oxygen partial pressure.

This Japanese Patent Application Laid-Open No. 2010-62424 makes it possible to increase the insulation resistance without increasing the resistance of the coil by using the manufacturing method, thereby providing a power inductor with favorable direct-current superimposition characteristics and a reduced magnetic loss.

### SUMMARY

### Problem to be Solved by the Disclosure

However, Japanese Patent Application Laid-Open No. 2011-249774 has difficulty in adequately ensuring insulation performance, although the oxidation layer formed by the oxidation of the soft magnetic particles is intended to ensure insulation performance.

More specifically, in the case of Japanese Patent Application Laid-Open No. 2011-249774, gaps are generated between the soft magnetic particles that have irregular shapes while the soft magnetic particles are coupled to each other by means of the oxidation layer, and there is thus a possibility that ingress of moisture into the gaps or ingress of a plating solution into the gaps in a subsequent step of plating will result in elution of the oxidation layer into the plating solution, thereby leading to degradation of insulation performance. Moreover, due to the generation of gaps between the soft magnetic particles as described above, there is a possibility of leading to decreased strength of the component body, and it is difficult to ensure sufficient reliability.

On the other hand, in the case of Japanese Patent Application Laid-Open No. 2010-62424, it is believed that due to the fact that glass films can be formed over the entire surface of the magnetic alloy material, the generation of gaps between the glass films can be suppressed, thereby enhancing the insulation resistance.

However, the glass material containing Si0₂, B₂O₃, and ZnO as its main constituents, which is used in Japanese Patent Application Laid-Open No. 2010-62424, is likely to be eluted into plating solutions, and for this reason, there is a possibility that the glass material will be eluted into the plating solution during the subsequent process of plating, thereby leading to decreased insulation resistance.

The present disclosure has been achieved in view of these circumstances, and an object of the present disclosure is to provide a magnetic material composition which can suppress ingress of moisture and plating solutions between magnetic alloy particles, and ensure favorable insulation performance without impairing any magnetic property, and various types of coil components using the magnetic material composition.

### Means for Solving the Problems

The inventors have, from earnest studies carried out on various combinations of magnetic alloy particles and glass constituents in order to achieve the object, come up with a finding that magnetic alloy particles that are able to have a passivation film formed on the surfaces of the particles and a glass constituent containing Si, B, and an alkali metal with a softening point of 650 to 800° C. can be mixed so that the content of the glass constituent is 12 to 32 wt % with respect to the total of the magnetic alloy particles and glass constituent, and subjected to heat treatment to form a dense glass phase with favorable plating solution resistance between the magnetic alloy particles, thereby providing a magnetic material composition which can ensure favorable insulation performance without impairing any magnetic property.

The present disclosure has been achieved on the basis of this finding, and a magnetic material composition according to the present disclosure includes: magnetic alloy particles with a passivation film formed on the surfaces of the particles; and a glass constituent containing Si, B, and an alkali metal with a softening point of 650 to 800° C., and the composition is characterized in that the content of the glass constituent is 12 to 32 wt % with respect to the total of the magnetic alloy particles and the glass constituent, and a glass phase formed from the glass constituent is formed between the magnetic alloy particles.

Thus, due to the fact that the dense glass phase with favorable plating solution resistance is formed between the magnetic alloy particles with the passivation film formed on the surfaces, the generation of gaps can be suppressed between the magnetic alloy particles, ingress of moisture and plating solutions can be avoided as much as possible, and the elution of the glass constituent into plating solutions can be suppressed. As a result, a magnetic material composition can be achieved which can ensure desired favorable insulation performance without impairing any magnetic property such as initial magnetic permeability.

Furthermore, the magnetic material composition according to the present disclosure is preferably obtained through heat treatment.

Thus, it is ensured that the passivation film is formed on the surfaces of the magnetic alloy particles, and the melted glass constituent can wet and spread between the magnetic alloy particles to form a desired dense glass phase, thereby ensuring desired insulation performance.

Moreover, in the magnetic material composition according to the present disclosure, the magnetic alloy particles preferably include either of a Fe—Si—Cr based material containing at least Fe, Si, and Cr, and a Fe—Si—Al based material containing at least Fe, Si, and Al.

As just described, the magnetic alloy particles containing Cr or Al that is more likely to be oxidized than Fe makes it possible to easily form a passivation film composed of a Cr oxide or an Al oxide on the surfaces of the magnetic alloy particles.

Furthermore, in the magnetic material composition according to the present disclosure, the alkali metal preferably includes at least one selected from K, Na, and Li.

This makes it possible to form a desired dense glass phase between the magnetic alloy particles, without eluting the glass constituent into plating solutions.

Moreover, in the magnetic material composition according to the present disclosure, the glass constituent preferably contains no Zn.

In this case, because the glass constituent contains therein no Zn which is likely to be eluted into plating solutions, the degradation of insulation performance, which is caused by elution of the glass constituent into plating solutions, can be avoided even when plating is carried out in a subsequent step.

A coil component according to the present disclosure is characterized in that a magnetic core is formed from any of the magnetic material compositions described above.

A coil component according to the present disclosure is a coil component with a coil conductor buried in a component body, which is characterized in that the component body is formed from any of the magnetic material composition described above.

### Advantageous Effect of the Disclosure

The magnetic material composition according to the present disclosure includes: magnetic alloy particles with a passivation film formed on the surfaces of the particles; and a glass constituent containing Si, B, and an alkali metal with a softening point of 650 to 800° C., and the composition is characterized in that the content of the glass constituent is 12 to 32 wt % with respect to the total of the magnetic alloy particles and the glass constituent, and a glass phase formed from the glass constituent is formed between the magnetic alloy particles. Thus, the generation of gaps can be suppressed between the magnetic alloy particles, ingress of moisture and plating solutions can be avoided as much as possible, and the elution of the glass constituent into plating solutions can be suppressed. Thus, a magnetic material composition can be achieved which can ensure desired favorable insulation performance without impairing any magnetic property such as initial magnetic permeability.

The coil component according to the present disclosure includes the magnetic core formed from any of the magnetic material compositions described above, and a coil component preferred for a high-frequency choke coil or the like can be thus achieved, which has favorable moisture absorption resistance and plating solution resistance, and can ensure desired insulation performance without impairing any magnetic property such as initial magnetic permeability.

Moreover, the coil component according to the present disclosure includes the coil conductor buried in the component body, and the component body formed from any of the magnetic material compositions described above, and a coil component preferred for a laminated inductor or the like can be thus achieved, which has favorable moisture absorption resistance and plating solution resistance, and can ensure desired insulation performance without impairing any magnetic property such as initial magnetic permeability.

### BRIEF DESCRIPTION OF THE DRAWINGS

FIG. 1 is a cross-sectional view illustrating an embodiment of a laminated inductor as a coil component, which is manufactured with the use of a magnetic material composition according to the present disclosure.

FIG. 2 is an exploded perspective view of a laminated body for explaining a method for manufacturing the laminated inductor.

### DETAILED DESCRIPTION

Next, an embodiment of the present disclosure will be described in detail.

The magnetic material composition according to the present disclosure includes: magnetic alloy particles with a passivation film formed on the surfaces of the particles; and a glass constituent containing Si, B, and an alkali metal with a softening point of 650 to 800° C., the content of the glass constituent is 12 to 32 wt % (corresponding to 29 to 61 vol % in volume percentage) with respect to the total of the magnetic alloy particles and the glass constituent, and a glass phase formed from the glass constituent is formed between the magnetic alloy particles.

Thus, due to the fact that the dense glass phase with favorable plating solution resistance is formed between the magnetic alloy particles with the passivation film formed on the surfaces, the generation of gaps can be suppressed between the magnetic alloy particles, ingress of moisture and plating solutions can be avoided as much as possible, and the elution of the glass constituent into plating solutions can be suppressed. As a result, a magnetic material composition can be achieved which can ensure desired favorable insulation performance without impairing any magnetic property such as initial magnetic permeability.

This magnetic material composition will be described below in detail.

(1) Magnetic Alloy Particle

The magnetic alloy particles form a main constituent of the present magnetic material composition, while there is need to use magnetic alloy particles that are able to have a passivation film formed on the surfaces of the particles, because the electrical conduction provided by the magnetic alloy particles electrically connected to each other results in failure to ensure insulation performance.

More specifically, the magnetic alloy particles are not to be considered particularly limited as long as the particles contain a metal species that is able to form a passivation film, for example, magnetic alloy particles can be used which contain a metal such as Cr and Al, which is more likely to be oxidized than Fe. Specifically, a Fe—Si—Cr based material containing at least Fe, Si, and Cr and a Fe—Si—Al based material containing at least Fe, Si, and Al can be preferably used.

(2) Type of Glass Constituent

The glass is composed of: a net-like oxide that makes itself amorphous to form a net-like network structure; a modifier oxide that modifies the net-like oxide to make an amorphous oxide although the modifier oxide fails to make itself amorphous; an intermediate oxide that is intermediate between the net-like oxide and the modifier oxide; etc. Among these oxides, both SiO₂ and B₂O₃ act as net-like oxides, and form essential constituents.

Furthermore, alkali metal oxides such as Na₂O, K₂O, and Li₂O are known as the modifier oxide, and ZnO and the like are known as the intermediate oxide.

However, it is not preferable to contain ZnO, because ZnO is likely to be eluted into plating solutions.

On the other hand, alkali metal oxides are unlikely to be eluted into plating solutions, and able to form a dense glass phase which is excellent in plating solution resistance, when the oxides are contained along with SiO₂ and B₂O₃.

Therefore, an alkaline borosilicate glass constituent containing Si, B, and an alkali metal such as K, Na, and Li is used in the present embodiment.

(3) Softening Point of Glass Constituent

A mixture of the magnetic alloy particles and the glass constituent can be subjected to heat treatment to form a dense glass phase between the magnetic alloy particles.

However, when the softening point of the glass constituent is less than 650° C., the content of the Si constituent in the glass constituent is excessively reduced, and for this reason, the glass constituent is unfavorably more likely to be eluted into the plating solution during the process of plating.

On the other hand, when the softening point of the glass constituent exceeds 800° C., the content of the Si constituent in the glass constituent is excessively increased to decrease the fluidity of the glass constituent, the glass constituent fails to sufficiently wet and spread between the magnetic alloy particles even when heat treatment is applied, and there is a possibility that densification of the glass phase will be inhibited, or gaps will remain between the magnetic alloy particles. Then, as a result, ingress of moisture or plating solutions is more likely to be caused between the magnetic alloy particles, and there is a possibility of leading to deterioration in moisture absorption resistance or plating solution resistance.

Thus, in the present embodiment, an adjustment is made so that the softening point of the glass constituent is 650° to 800° C.

(4) Content of Glass Constituent

As described above, the formation of the glass phase on the surfaces of the magnetic alloy particles allows the insulation performance and magnetic property to be improved.

However, when the content of the glass constituent is less than 12 wt % (less than 29 vol %) in the total of the magnetic alloy particles and glass constituent, that is, the magnetic raw material, the glass constituent fails to sufficiently fill the spaces between the magnetic alloy particles to form gaps, and for this reason, there is a possibility that ingress of moisture into the gaps will lead to deterioration in moisture absorption resistance.

On the other hand, when the content of the glass constituent in the magnetic raw material exceeds 32 wt % (61 vol %), there is a possibility that the excessive glass constituent will lead to deterioration in the magnetic property.

Thus, in the present embodiment, an adjustment is made so that the content of the glass constituent in the magnetic raw material is 12 to 32 wt %.

This magnetic material composition can be manufactured as follows.

First, as the magnetic alloy particles, a Fe—Si—Cr based material or a Fe—Si—Al based material is prepared which is able to form a passivation film such as a Cr oxide or an Al oxide on the surface through heat treatment.

Furthermore, as the glass constituent, a Si—B—A—O based glass material is prepared which contains SiO₂, B₂O₃, and A₂O (A represents an alkali metal such as K, Na, and Li).

Then, the magnetic alloy particles and the glass constituent are weighed so that the content of the glass constituent is 12 to 32 wt % with respect to the total of the magnetic alloy particles and glass constituent, and mixed to prepare a magnetic raw material.

Next, an organic solvent, an organic binder, and additives such as a dispersant and a plasticizer are weighed in appropriate amounts, kneaded along with the magnetic raw material, and made into paste to prepare a magnetic paste.

Then, the magnetic paste is subjected to a forming process such as a doctor blade method to prepare a compact, and the compact is then subjected to binder removal treatment at a temperature of 350 to 500° C., and thereafter, to firing through heat treatment for on the order of 90 to 120 minutes at a temperature of 800 to 900° C., thereby preparing the magnetic material composition.

As just described, the present magnetic material composition includes: magnetic alloy particles with a passivation film formed on the surfaces of the particles; and a glass constituent containing Si, B, and an alkali metal with a softening point of 650 to 800° C., the content of the glass constituent in the magnetic raw material is 12 to 32 wt %, and a glass phase formed from the glass constituent is formed between the magnetic alloy particles.

Thus, due to the fact that the dense glass phase with favorable plating solution resistance is formed between the magnetic alloy particles with the passivation film formed on the surfaces, the generation of gaps can be suppressed between the magnetic alloy particles, ingress of moisture and plating solutions can be avoided as much as possible, and the elution of the glass constituent into plating solutions can be suppressed. As a result, a magnetic material composition can be achieved which can ensure desired favorable insulation performance without impairing any magnetic property such as initial magnetic permeability.

Next, a coil component using the present magnetic material composition will be described in detail.

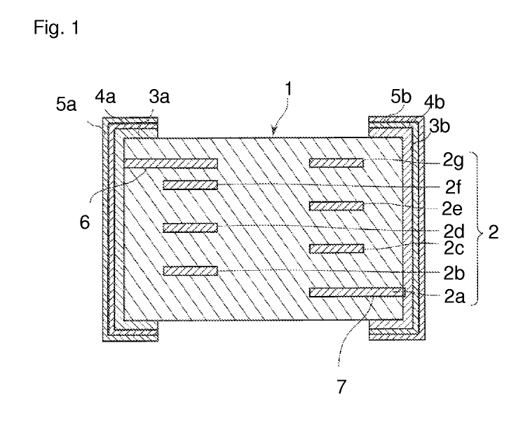

FIG. 1 is a cross-sectional view of a laminated inductor as a coil component according to the present disclosure.

This laminated inductor is composed of: a component body 1 formed from the present magnetic material composition; a coil conductor 2 built in the component body 1; external conductors 3a, 3b formed on both ends of the component body 1; and first plating films 4a, 4b such as Ni and second plating films 5a, 5b such as Sn and solder, which are formed on the surfaces of the external conductors 3a, 3b.

In addition, the coil conductor 2 has internal conductors 2a to 2g formed so as to provide a predetermined conductor pattern, which are electrically connected in series through via conductors (not shown), and wound in a coiled form. Furthermore, in this laminated inductor, an extraction part 6 of the internal conductor 2g is electrically connected to the external electrode 3a, and an extraction part 7 of the internal conductor 2a is electrically connected to the other external electrode 3b.

Next, a method for manufacturing the laminated inductor described above will be described in detail.

First, a magnetic paste is prepared in the same way and in accordance with the same procedure as described above.

Further, a conductive powder such as an Ag powder is subjected to kneading with the addition of a varnish and an organic solvent to the powder, thereby preparing a conductive paste for internal conductors (hereinafter, referred to as an “internal conductor paste”).

Next, the magnetic paste and internal conductor paste are used to prepare a laminated body.

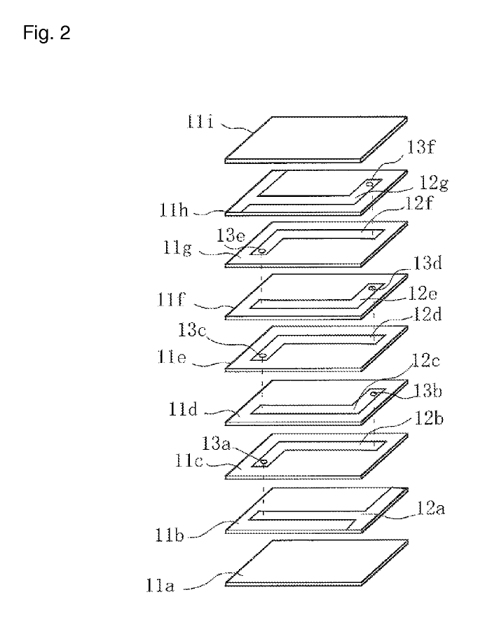

FIG. 2 is a perspective view of the laminated body.

First, the magnetic paste is applied onto a base film such as a PET film, and dried to prepare magnetic sheets 11a, 11b. Then, the internal conductor paste is applied by a screen printing method or the like onto the surface of the magnetic sheet 11b, and dried to form a conductor layer 12a in a predetermined pattern.

Then, the magnetic paste is applied onto the magnetic sheet 11b with the conductor layer 12a formed thereon, and dried to prepare a magnetic sheet 11c. Then, the internal conductor paste is applied by a screen printing method or the like onto the surface of the magnetic sheet 11c, and dried to form a conductor layer 12b in a predetermined pattern. It is to be noted that in the formation of the magnetic sheet 11c, a via hole 13a is formed so that the conductor layer 12b and the conductor layer 12a are able to provide conduction.

Thereafter, the magnetic paste and the internal conductor paste are used in the same way and in accordance with the same procedure to sequentially form magnetic sheets 11d to 11i and conductor layers 12c to 12g, and via holes 13b to 13f are further formed in the formation of the magnetic sheets 11d to 11h so that the upper and lower conductor layers provide conduction, thereby preparing the laminated body.

Then, this laminated body is put in a sagger, and subjected to binder removal treatment at a temperature of 300 to 500° C., and thereafter to firing through heat treatment at a temperature of 800 to 900° C., thereby preparing the component body 1.

Thereafter, a paste for external electrodes, which contains Ag or the like as its main constituent, is applied onto both ends of the component body 1, and subjected to baking treatment to form the external electrodes 3a, 3b, and further, plating such as electrolytic plating is carried out to sequentially form the first plating films 4a, 4b such as Ni or Cu and the second plating films 5a, 5b such as Sn or solder, thereby preparing a laminated inductor.

As just described, the present laminated inductor has the coil conductor 2 buried in the component body 1, and has the component body 1 formed from the magnetic material composition, and a laminated inductor can be thus achieved which has favorable moisture absorption resistance and plating solution resistance, and can ensure desired insulation performance without impairing any magnetic property such as initial magnetic permeability.

It is to be noted that the present disclosure is not to be considered limited to the embodiment described above, but various modifications can be made without departing from the spirit and scope of the disclosure. While the laminated inductor has been illustrated as a coil component in the embodiment described above, it is also preferable to form a magnetic core by forming the magnetic material composition into a disc shape or a ring shape, and wind a coil around the magnetic core for use, thereby making it possible to achieve a coil component preferred for a high-frequency choke coil or the like, which has favorable moisture absorption resistance and plating solution resistance, and can ensure desired insulation performance without impairing any magnetic property such as initial magnetic permeability, as in the case of the laminated inductor described above.

Next, examples of the present disclosure will be described specifically.

### EXAMPLE 1

Prepared were the commercially available Fe—Si—Cr based magnetic alloy particles (magnetic alloy particles A), Fe—Si—Al based magnetic alloy particles (magnetic alloy particles B), and Fe—Si based magnetic alloy particles (magnetic alloy particles C) shown in Table 1. It is to be noted that these magnetic alloy particles A to C were all 6 μm in average particle size.

Table 1 shows composition ratios for each of the magnetic alloy particles A to C.

TABLE 1

| | |
|---|---|
| Type of Magnetic | Composition Ratio (weight %) |

| Alloy Powder | Fe | Si | Cr | Al |
|---|---|---|---|---|
| A | 92.0 | 3.5 | 4.5 | — |
| B | 92.0 | 8.0 | — | 10.0 |
| C | 96.5 | 3.5 | — | — |

Furthermore, respective glass materials of Si0₂, B₂O₃, K₂O, and ZnO were prepared, and blended so as to provide the compositions shown in Table 2, thereby preparing glass constituents a to f. Then, the softening points of the glass constituents a to f were measured in conformity with JIS 3103-1. It is to be noted that the glass constituents were all 1 μm in average particle size.

Table 2 shows the composition ratios and softening points for each of the glass constituents a to f.

TABLE 2

| | | |
|---|---|---|
| Type of | Composition Ratio | Softening |
| Glass | (weight %) | Point |

| Constituent | SiO₂ | B₂O₃ | K₂O | ZnO | (° C.) |
|---|---|---|---|---|---|
| a | 61.0 | 37.0 | 2.0 | — | 580 |
| b | 70.0 | 28.0 | 2.0 | — | 650 |
| c | 79.0 | 19.0 | 2.0 | — | 760 |
| d | 82.0 | 16.0 | 2.0 | — | 790 |
| e | 86.0 | 12.0 | 2.0 | — | 850 |
| f | 47.0 | 41.0 | — | 12.0 | 600 |

Next, the magnetic alloy particles A to C and the glass constituents a to f were weighed so that the content of the glass constituent met the ratio by weight as shown in Table 3 with respect to the total of the magnetic alloy particles and glass constituent, and the particles and constituent were mixed. Then, dihydro terpinyl acetate as a solvent, ethyl cellulose as an organic binder, a dispersant, and a plasticizer were weighed in amounts of 26 parts by weight, 3 parts by weight, 1 part by weight, and 1 part by weight, respectively, with respect to 100 parts by weight of the magnetic raw material, and kneaded to make a paste, thereby preparing magnetic pastes of sample numbers 1 to 19.

Next, a step of applying the magnetic pastes of sample numbers 1 to 19 onto PET films and drying the pastes was repeated to prepare magnetic sheets of 0.5 mm in thickness.

Then, the magnetic sheets were peeled from the PET films, and subjected to pressing and punching into a disc shape of 10 mm in diameter to prepare disc-shaped compacts.

Likewise, the magnetic sheets were peeled from the PET films, and subjected to pressing and punching into a ring shape of 20 mm in outside diameter and 12 mm in inside diameter to prepare ring-shaped compacts.

Then, these compacts were subjected to binder removal treatment at 350° C. under air atmosphere, and then to firing through heat treatment for 90 minutes at a temperature of 850° C., thereby preparing respective disc-shaped samples and ring-shaped samples of sample numbers 1 to 19.

Next, the disc-shaped samples of sample numbers 1 to 19 were subjected to weight measurement, and then immersed in water for 60 minutes, and thereafter, each sample was pulled up, moisture on the surface was sponged for removal, and the weight after the moisture removal was then measured to calculate the water absorption percentage on the basis of the increase in weight between before and after the immersion.

Furthermore, a conductive paste containing Ag as its main constituent was applied onto both principal surfaces of the disc-shaped samples of sample numbers 1 to 19, and baked for 5 minutes at a temperature of 700° C. to form electrodes. Thereafter, these samples were subjected to electrolytic plating to sequentially prepare Ni films and Sn films on the electrode surfaces.

Then, a direct-current voltage of 50 V was applied to these samples to measure the resistance values after 1 minute, and the resistivity log ρ (ρ: Ω·cm) was figured out from the measurement values and the sample dimensions.

Moreover, the ring-shaped samples of sample numbers 1 to 19 were housed in a magnetic permeability measurement jig (16454A-s from Agilent Technologies, Inc.), and an impedance analyzer (E4991A from Agilent Technologies, Inc.) was used to measure the initial magnetic permeability μ at a measurement frequency of 1 MHz.

Table 3 shows the contents of the magnetic alloy particles and glass constituent in the magnetic raw material, the water absorption percentage, the resistivity log ρ, and the initial magnetic permeability μ in the case of sample numbers 1 to 19.

In this case, the samples with the water absorption percentage of 1.5% or less were determined as non-defective products, whereas the samples with the percentage in excess of 1.5% were determined as defective products. In addition, the samples with the resistivity log ρ of 6 or more were determined as non-defective products, whereas the samples with the resistivity less than 6 were determined as defective products. Moreover, the samples with the initial magnetic permeability μ of 4 or more were determined as non-defective products, whereas the samples with the permeability less than 4 were determined as defective products.

TABLE 3

| | Magnetic Alloy | | Glass | | Water | | Initial |
|---|---|---|---|---|---|---|---|
| | Powder | | Constituent | | Absorption | Resistivity | Magnetic |
| Sample | | Content | | Content | Percentage | log ρ | Permeability |
| No. | Type | (weight %) | Type | (weight %) | (%) | (ρ: Ω · cm) | μ (—) |
| 1* | A | 100 | — | 0 | 4.8 | 6.5 | 19 |
| 2* | A | 95 | c | 5 | 3.6 | 6.5 | 11 |
| 3 | A | 88 | c | 12 | 1.5 | 6.7 | 7.4 |
| 4 | A | 78 | c | 22 | 0.1 | 7.3 | 5.4 |
| 5 | A | 68 | c | 32 | 0.1 | 8.1 | 4.6 |
| 6* | A | 50 | c | 50 | 0.1 | 8.3 | 3.2 |
| 7* | A | 78 | a | 22 | 0.2 | 4.1 | 5.8 |
| 8 | A | 88 | b | 12 | 1.5 | 6.6 | 7.5 |
| 9 | A | 78 | b | 22 | 0.4 | 7.1 | 5.6 |
| 10 | A | 68 | b | 32 | 0.1 | 8.0 | 4.7 |
| 11 | A | 88 | d | 12 | 1.4 | 6.5 | 7.3 |
| 12 | A | 78 | d | 22 | 0.7 | 7.3 | 5.4 |
| 13 | A | 68 | d | 32 | 0.2 | 8.2 | 4.6 |
| 14* | A | 78 | e | 22 | 4.3 | 8.2 | 5.6 |
| 15 | B | 88 | c | 12 | 1.3 | 6.8 | 7.7 |
| 16 | B | 78 | c | 22 | 0.2 | 7.5 | 6.2 |
| 17 | B | 68 | c | 32 | 0.1 | 8.1 | 5.0 |
| 18* | C | 78 | c | 22 | 0.3 | Electrical | — |
| | | | | | | Conduction | |
| 19* | A | 78 | f | 22 | 0.2 | 3.9 | 5.7 |

*outside the scope of the present disclosure

Sample number 1 has resulted in a high water absorption percentage of 4.8%. This is believed to be because sample number 1 contains no glass constituent, and thus has gaps generated between the magnetic alloy particles without any glass phase formed therebetween, with moisture ingress between the gaps.

Sample number 2 also has resulted in a high water absorption percentage of 3.6%. This is believed to be because sample number 2 contains the glass constituent, while the glass constituent in the magnetic raw material has a low content of 5 wt %, and for this reason, has gaps generated between the magnetic alloy powders without any adequate glass phase formed therebetween, thereby resulting in moisture ingress between the gaps, as in the case of sample number 1.

It has been determined that sample number 6 has a degraded magnetic property with the low initial magnetic permeability μ of 3.2, because the content of the glass constituent in the magnetic raw material is 50 wt %, which is excessive.

It has been determined that sample number 7 is inferior in insulation performance, with the resistivity log ρ decreased to 4.1. This is believed to be because the glass constituent was eluted into the plating solution, and for this reason, the insulation performance was decreased, due to the use of the glass constituent a with a softening point of 580° C. and the low SiO₂ content of 61 wt % in the case of sample number 7.

Sample number 14 has a high water absorption percentage of 4.3%. This is believed to be because, in the case of sample number 14, due to the use of the glass constituent e with a softening point of 850° C. and the high SiO₂ content of 86 wt %, the fluidity of the glass constituent was decreased, the glass constituent failed to wet and expand over the entire magnetic alloy particles during the heat treatment, and gaps were formed between the magnetic alloy particles to fail to achieve a dense glass phase.

Sample number 18 has failed to have any passivation film formed on the particle surfaces even when the heat treatment was carried out, thereby resulting in a conduction state, because of using the Fe—Si based magnetic alloy powder C and containing no metal such as Cr or Al, which is more likely to be oxidized than Fe.

It has been determined that in the case of sample number 19, because of the use of the glass constituent f containing ZnO, the ZnO was eluted into the plating solution to decrease the resistivity log ρ to 3.9 and thus degrade the insulation performance.

In contrast, in the case of sample numbers 3 to 5, 8 to 13, and 15 to 17, it has been determined that favorable insulation performance is achieved without impairing the magnetic property, with the water absorption percentage of 1.5% or less, the resistivity log ρ of 6 or less, and the initial magnetic permeability μ of 4 or more, because of using the magnetic alloy powder A or magnetic alloy powder B and the glass constituents b to d with a softening point of 650 to 800° C., the glass constituents contained in the magnetic raw material in an amount of 12 to 32 wt %, all within the scope of the present disclosure.

### EXAMPLE 2

Prepared were the magnetic pastes used in sample numbers 4, 7, 9, 12, and 19 according to Example 1.

Furthermore, an internal conductor paste containing an Ag powder, a varnish, and an organic solvent was prepared.

Then, applying the magnetic pastes onto PET films and drying the pastes were repeated a predetermined number of times to prepare magnetic sheets. Then, the internal conductor paste was applied to the surface of the magnetic sheet with the use of a screen printing method, and dried to form a conductor layer in a predetermined pattern.

Then, the magnetic paste was applied onto the magnetic sheet with the conductor layer formed thereon, and dried to prepare a magnetic sheet. In this case, a via hole was formed in a predetermined position of the magnetic sheet. Then, the internal conductor paste was applied to the surface of the magnetic sheet with the use of a screen printing method, and dried to form a conductor layer in a predetermined pattern. In this case, the conductor layer was adapted to provide conduction to the initially formed conductor layer through the via hole. Thereafter, the magnetic paste and the internal conductor paste were used in the same way and in accordance with the same procedure to sequentially form magnetic sheets and conductor layers, thereby forming a laminated body as shown in FIG. 2.

Then, the laminated body was put in a sagger, heated for 2 hours at a temperature of 350° C. in the air atmosphere to achieve binder removal treatment, and then subjected to firing treatment for 90 minutes at a temperature of 850° C. in the air atmosphere to obtain a component body.

Then, a paste for external electrodes, containing Ag or the like as its main constituent, was applied to both ends of the component body, dried, and then subjected to baking treatment for 5 minutes at a temperature of 700° C. in the air atmosphere to form external electrodes, thereby preparing samples of sample numbers 4′, 7′, 9′ 12′, and 19′.

Next, ten pieces for each of the thus prepared samples were encapsulated in resin to make end surfaces of the samples stand, the end surfaces were polished along the length direction of the samples, and cross sections at approximately ½ in the length direction were observed under an optical microscope.

In the case of sample number 7′, a trace of glass elution caused by ingress of the plating solution has been recognized. This is believed to be because in the case of sample number 7′, the glass constituent was eluted into the plating solution without being able to form any dense glass phase, due to the low softening point of 580° C., and for this reason, the low SiO₂ content of 61 wt % in the glass constituent.

In addition, in the case of sample number 19′, a trace of glass elution into the plating solution has been recognized as in the case of sample number 7′, because of the glass constituent containing therein the ZnO which is likely to be eluted into the plating solution.

In contrast, in the case of sample numbers 4′, 9′, and 12′, it has been recognized that favorable plating solution resistance is achieved without any trace of the glass constituent eluted into the plating solution, because of the softening point of the glass constituent from 650° C. to 800° C..

### INDUSTRIAL APPLICABILITY

Coil components such as choke coils and laminated inductors can be achieved in which magnetic alloy particles with favorable moisture absorption resistance and plating solution resistance and with favorable insulation performance are used for magnetic cores or component bodies without impairing any magnetic property.

1. A magnetic material composition comprising:
magnetic alloy particles with a passivation film formed on the surfaces of the particles; and
a glass constituent containing Si, B, and an alkali metal, the glass constituent having a softening point of 650 to 800° C.,
wherein the content of the glass constituent is 12 to 32 wt % with respect to a total of the magnetic alloy particles and the glass constituent, and
a glass phase formed from the glass constituent is formed between the magnetic alloy particles.

2. The magnetic material composition according to claim 1, wherein the composition is obtained by heat treatment.

3. The magnetic material composition according to claim 1, wherein the magnetic alloy particles include any of a Fe—Si—Cr based material containing at least Fe, Si, and Cr, and a Fe—Si—Al based material containing at least Fe, Si, and Al.

4. The magnetic material composition according to claim 1, wherein the alkali metal includes at least one selected from K, Na, and Li.

5. The magnetic material composition according to claim 1, wherein the glass constituent contains no Zn.

6. A coil component wherein a magnetic core is formed from the magnetic material composition according to claim 1.

7. A coil component with a coil conductor buried in a component body,
wherein the component body is formed from the magnetic material composition according to claim 1.
